(19) United States
(12) Patent Application Publication
(10) Pub. No.: US 2012/0126604 A1
(43) Pub. Date: May 24, 2012

(54) VEHICLE SEAT DEVICE HAVING FIXATING LEG PARTS

(75) Inventor: Patrick Kuenzler, Zurich (CH)

(73) Assignee: INNO-MOTION AG, Zurich (CH)

(21) Appl. No.: 13/387,577

(22) PCT Filed: Jul. 20, 2010
(86) PCT No.: PCT/EP2010/004421

§ 371 Date: Jan. 27, 2012

(30) Foreign Application Priority Data
Jul. 30, 2009 (EP) 09009852.6

(51) Int. Cl. A47C 7/50; A41D 1/00; B60N 2/64; B60N 2/62; A47C 7/38

(52) U.S. Cl. 297/391; 297/423.17; 297/452.1; 2/69

(57) ABSTRACT

The invention relates to a dimensionally-stable leg part that can be allocated to a seat device, which leg part is respectively allocated to a left or right upper leg of a person from the knee to the hip and is in close contact with the upper leg form, wherein the leg part contacts flat to the outside of the hip, on the underside of the thigh at least on the distal end, and at least inside and outside on the knee. The invention is further directed to seat devices, particularly vehicle seat devices and vehicle seat extraction systems having said leg parts.

In addition, the invention relates to a seat device, preferably a vehicle seat device or vehicle seat extraction system having a U-shaped support device for the back underneath the shoulder having lateral support for the chest, which solely surrounds the adjacent back and chest.

The invention relates to a dimensionally stable leg part that can be allocated to a seat device, which leg part is respectively allocated to a left or right upper leg of a person from the knee to the hip and is in close contact with the upper leg form, wherein the leg part contacts flat to the outside of the hip, on the underside of the thigh at least on the distal end, and at least inside and outside on the knee. The invention is further directed to seat devices, particularly vehicle seat devices and vehicle seat extraction systems having said leg parts.

In addition, the invention relates to a seat device, preferably a vehicle seat device or vehicle seat extraction system having a U-shaped support device for the back underneath the shoulder having lateral support for the chest, which solely surrounds the adjacent back and chest.

### PRIOR ART

Seat devices with seat parts for supporting a seated person are known. The person can be seated on the two seat parts, wherein the seat parts can support the persons independently of one another. WO 93/19648 and WO 99/16335 relate to active-dynamic two-part seat devices, wherein each seat half is movable independent of the other in order to improve the comfort of the seated person. In addition, WO 2009/070468 and WO 2009/042688 disclose seat devices having seat parts mounted independently of each other, wherein separately mounted dimensionally stable seat part elements that receive the upper leg from the hips to the beginning of the knee joint are used, which seat parts contact the respective upper leg closely and are form fitting. Common to all these two-part seat devices is that the seating comfort is the focus due to the individual mounting of the seat or leg halves. Such comfortable and very movably mounted divided seat devices are in fact thoroughly suitable for the transport of passengers, but not for vehicles in which the occupants can expect rapid motion change and G-forces.

In the cockpits of vehicles which stress the occupants with this type of rapid motion changes and G-forces, such that the occupants are no longer able to compensate through their own sense of balance, e.g. in aircraft and spacecraft, especially combat and aerobatic aircraft as well as corresponding helicopters, sports and racing cars, racing boats, etc., the focus of development lies less in comfortable suspension, but more in the firm fixation of the pilot and any co-pilot or passengers. In cockpits of this type, the seat devices are adapted and closely contact the body shape, especially the back and sides of the body as well as occasionally the shape of the leg. Also well known are the racing seats from Recaro which are individually adapted to the driver and front passenger, which seats impart strong lateral support and ergonomically support the spine. In the case of racing seats, the basic shapes are often adapted precisely to the contours of the seated pilots by means of special polymer foams.

Foam-filled seats indeed adapt to the driver but do not offer the body enough play for small tensing and corrective movements and are not suitable as reference surfaces for determining the position and posture of the body due to their mostly non-smooth surface. Although foam-filled seats, as commonly used in racing cars, offer good support, they also considerably limit the perception of the vehicle by the body and also tensioning and balancing movements of the body, especially around the spine and around the hip and shoulder area.

However, not only lateral support and protection of the spine are important. During braking maneuvers and accidents, the driver and passenger are exposed to extreme loads which can launch them forward from the seat. Whereas two and three-point safety belts are used during normal transportation, four-point and multi-point safety belts are used in military and sports vehicles, which four- and multi-point safety belts prevent “submarining” in extreme situations, i.e. sliding under the belt, by means of a further attachment point between the legs of the seated person.

A further problem for vehicle seats in “extreme vehicles” is the constant conscious and often subconscious counterreaction of the pilot's body to the vehicular forces, particularly the lateral forces, affecting the pilot. During said compensation behavior, the pilot wedges his feet and/or twists his legs, especially the knees, inwards, or against the vehicle wall, etc. This constant conscious or subconscious compensation movement affects the concentration, and also the direct driving behavior of the driver, who must take into account his displaced and possibly angled inwards sitting position while steering and in response to his physical perception of the vehicle and, due to the strong muscular forces, said compensation movement reduces the available sensitivity of the lower half of the body during the exercise of steering and perceiving vehicular momentums. In addition, the distal inner side of the upper leg remains unused as a support and a perception surface in current seats. There is great potential in both areas here because a sensitive body surface, on which pressure is perceived in an emotionally positive manner, remains unused.

In “extreme vehicles”, the vehicle occupants are protected primarily by the surrounding vehicle chassis, e.g. by struts and complete safety cages. By this means direct effects from the outside can be largely attenuated, but the vehicle chassis or the safety cage are frequently launched so violently against the occupants that a padding becomes necessary around the vehicle seat (foam sheathing for the safety cages, airbags, etc.). Additional equipment to protect the person himself in the cockpit against mechanical effects, apart from the possible padding of clothes, is foregone for weight reasons.

When an accidental injury first occurs, the occupants must be quickly released from the cockpit without consequent injury. The removal of an injured and possibly immobilized person, or one with only limited movement, from the often narrow cockpit and the seat which closely contacts the body, can prove to be problematic and even dangerous, e.g. if neck or spinal injuries have occurred. To solve this problem, some development concepts for extractable safety seat systems for F1 cockpits were presented at the Motorsports Engineering Conference & Exposition in Dearborn, Michigan, 13 to 16 November, and described in document, SAE Technical Paper Series 2000-01-3540. In one of these concepts, a waistcoat-like device is strapped around the thorax and possibly combined with a neck brace (KED system, “Kendrick Extraction Device”) while the injured driver is still in the cockpit, wherein, however, pressure is exerted on the chest during extraction which can impede breathing. As an alternative, the “Lear Seat Shell Design” was presented in which the driver is seated in a one-piece seating shell adapted to the vehicle, extending from the upper leg to the shoulders, and, in case of injury, the seating shell together with the driver belted thereto can be removed from the cockpit. As a further and future development, the “Lear F1 Collapsible Seat Concept” is described, a seat made of seat elements respectively allocated to the individual body parts of the driver and flexibly connected to each other such that, after removal together with the injured driver, the seat can be unbent by means of the hinges at the seat elements to form a stretcher and thus allow further recumbent transport or acute care of the injured person. Said seat extraction system comprises flexibly connected segments to support the lower leg, upper thigh, pelvis, hip, chest and head, wherein all of the segments each enclose in a shell-like manner the back and the side of the body of the adjacent body part of the driver to impart lateral support.

The object of the invention is to provide an improved vehicle seat device and advantageous components therefore which are particularly suitable for vehicles in which extreme forces affect the seated person. In particular, the seat device should avoid the problem of submarining during a frontal collision or during hard braking, reduce the compensation behavior of seated persons with respect to strong lateral forces such as during cornering/banking, impart protection against mechanical influences from the outside and/or reduce the risk of injury during an emergency evacuation of a person from the vehicle seat.

These and other problems can be solved with a dimensionally stable leg part that can be allocated a seat device, which leg part is respectively allocated to a left or right upper leg of a person from the knee to the hip and is in close contact with the upper leg form, wherein the leg part contacts flat to the outside of the hip, on the underside of the thigh at least on the distal end, and at least inside and outside on the knee.

The leg parts according to the invention are dimensionally stable, i.e. they are substantially shape-retaining and in some embodiments are even rigid. Preferably, they are restricted only by moderate to heavy forces, and are preferably also elastically deformable. In a preferred embodiment, the person wearing it can, using their own strength, change the shape of the leg part only a small amount, and then flexibly. The leg part has correspondingly a high bending stiffness. The dimensional stability is associated with mechanical strength to protect the upper leg, the knee, and the hip from mechanical effects. In fixed combination with further elements of a seating device according to the invention, like a seat part and/or backrest, the spine is also protected in that a detrimental displacement of the hip relative to the spine is prevented or reduced.

Advantageously, the leg parts have for the purpose of allocation in a seat device at least one locking device on the side and/or underneath at the proximal end (hip) as well as optionally on the side and/or underneath along the upper leg up to the knee for the easiest and fastest fixable and detachable connection to a seat device and/or passenger compartment. Particularly preferably, the leg parts are lockably allocated externally and proximally to a seat section of the vehicle seat.

The terms “allocate”, “allocation”, “allocatable” and the like are to be understood such that two objects are brought into spatial connection to each other, for example, are fixed and if necessary releasably connected, wherein the allocation can be spatially rigid or movably equipped in one or more spatial directions according to the mechanical design. For example, the allocation of the leg parts to other components of a seat device is carried out directly to said components or indirectly, e.g. via components of a passenger compartment. The allocation and thus e.g. the angle between the leg parts and a seat surface, between a seat surface and a backrest, between a backrest and a neck support or headrest can, for example, be adjustably configured and thus are adapted to the requirements of the respective seated person. The connection(s) of the leg parts with other components of the vehicle seat and/or the passenger compartment can be rigid and fix said components, or said connection can be configured with limited flexibility and if necessary also elastically damping e.g. vibration damping. The vibration-damping connection(s) can then replace or support padding elements. A limited deflection of the connected leg parts, preferably laterally, optionally in connection with a rotational mobility of the upper leg, can facilitate the comfort of the seated person and the alignment against centrifugal forces. However, initial experiments showed that a fixation as rigid as possible of the leg part is necessary for perception of the vehicle. In addition, a fixation that is as rigid as possible of the leg parts leads to the driver remaining relaxed even during strong lateral centrifugal forces and the driver can concentrate better on the steering. This also has physiological benefits as the sensory perception and fine motor capability of the legs is increased by the muscular relaxation.

Advantageously, the leg parts are not padded at all or only slightly on the inner side, preferably only at one or more of the following positions: the inner and/or the outer side of the knee and/or the outer side of the hip. In a preferred embodiment, the inner sides of the leg parts are smooth because by this means a better sensor system of vehicle behavior can be imparted to the driver.

In a preferred embodiment, the leg parts are protected on the outside from the effects of force by shock-absorbing, preferably elastic damping elements, e.g. rubber pads. Advantageously and in a weight-saving manner, these elements are mounted at least at the proximal and distal ends, i.e. only in the area of the knee and the hip.

The shape of the leg parts follows the contour of the adjacent upper leg, preferably in close contact and thus reducing substantially the displacement or slippage of the upper leg in the leg part. The terms adjacent and especially in close contact find their limits where the pressure on the upper leg, the knee, or the hip is felt to be unpleasant. The allocation of the upper leg to the leg part, i.e. the connection of the two, takes place through the adjacent, preferably closely contacting fit, preferably in conjunction with fastening means like Velcro connections on the leg part and on the leg clothing, holding straps, snap locks, etc.

The leg part can be advantageously configured such that said leg part can be “pulled on” like an article of clothing and “worn” inside and outside the vehicle, e.g. like a ski boot. The fixation can thereby take place solely due to the shape and stiffness of the leg part or due to the shape in combination with holding elements, e.g. retaining straps, Velcro fasteners or the design of the leg part as part of a trouser leg. Consequently, preferred leg parts are connected to the person sitting in them in such a way that said leg part can be worn as an article of clothing by the person in the unfastened state from the vehicle seat. This has the advantage that the shape and preferably exactly fitted leg parts are comfortable, offer very good support, and that said leg parts can if necessary be put on and taken off outside of the vehicle. This is particularly advantageous as the process of establishing and releasing the physical connection to the vehicle can be extremely fast, depending on the type of connection, while the process of dressing can be carried out precisely, comfortably, and without time pressure.

As the leg parts are in contact at the upper leg, preferably in close contact, and pilots, front-seat occupants, and passengers of extreme vehicles usually wear warming protective clothing, e.g. a fire-retardant suit, the leg part (like a “leg garment”) is preferably at least partially air permeable, preferably perforated and, if necessary, covered with breathable materials.

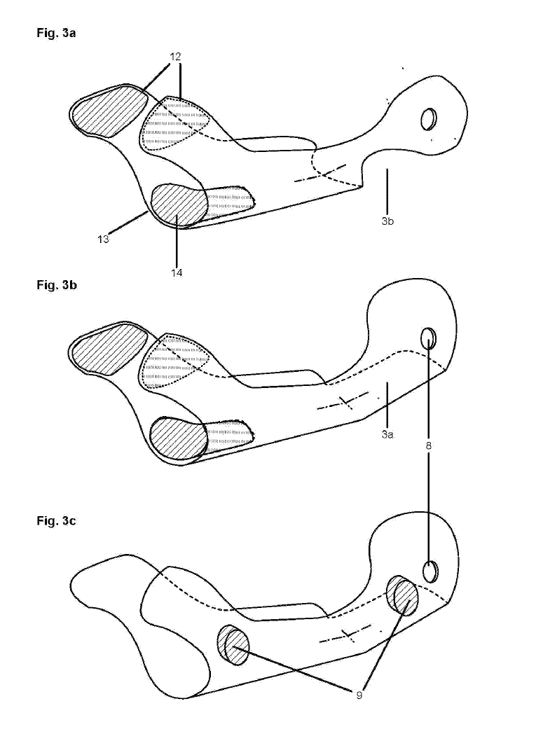

The leg parts according to the invention each flatly contact the outer side of the person at the hips, at least at the distal end underneath the respective upper leg and at least on the inner and outer sides of the respective knee. The leg part can, but it is in no way necessary, be implemented underneath the upper leg up to the hips as a seating surface. It is advantageous to omit the buttocks area for the person wearing the two leg parts, thus the seat, and is provided in the vehicle seat device by a further element, e.g. a seat cushion. Thus, the leg parts can be worn more comfortably outside the vehicle with more walking and standing comfort. FIG. 3a shows such an embodiment without a seat while FIGS. 3b and 3c show two embodiments having an integrated seat area, which can then be preferably designed to be padded. In the embodiments, the seat can itself be a part of the leg parts, which seat, however, in contrast to said leg parts, can be made from a flexible material, optionally with a damping/padded effect.

The leg parts are preferably open towards the top to facilitate the reception of the upper leg. Advantageously, at least the distal part is open towards the bottom around the knee to leave the hollow of the knee free. This promotes circulation and prevents circulatory problems, e.g. varicose veins. Preferably, the leg parts are located at least partially or completely on the upper side of the knee. In the latter case, the person wearing the leg part must slip into it. If the leg part contacts at the knee not only laterally but also at least partially at the top thereof, this effectively prevents forward slipping through of the seated person due to the effects of force. Since the leg diameter increases from the knee towards the hip, and the upper leg wedges itself in the knee area of the leg part during forward slipping, slipping through (“submarining”) is prevented or at least strongly slowed. Advantageously, the knee area is closed towards the top by means of a flexible restraint system like with a belt or Velcro fastener or a rigid or flexible buckle (e.g. as in ski boots).

In a preferred embodiment, at least one leg part at the distal end, preferably at the knee, is equipped with sensors, preferably on the inside, outside and/or underneath. Instead of this, or additionally, the leg parts can be provided with information devices. Sensors can e.g. measure and transmit the temperature, blood pressure, pulse, the pressure of the leg, knee and/or hip against the leg part, while information devices can communicate information with respect to the seated person e.g. through heat or pressure sequences, like e.g. the operating temperature of vehicle aggregates like the engine, jet or brakes or traction or the ground condition.

The leg parts can be allocated to a seat device independently of one another. Preferably, according to the invention, the left and right leg parts in seat devices are articulated or at least flexibly connected to each other, preferably at least at the proximal end (hip). The connection take place directly, e.g. via a seat section or a back support, or indirectly via components of the vehicle cabin.

The leg parts are preferably one-piece, i.e. the preferably dimensionally stable leg parts in close contact at the outer side at the hip, the underside at the upper leg, and the inner and outer sides at the knee are produced from one part, e.g. from plastics optionally having fiber, Kevlar, or carbon fiber elements. If the leg parts should comprise a plurality of components, then said components must be connected dimensionally stably with each other such that said components can ultimately function as a single part on the above-mentioned three points, and thus serve the upper leg as a kind of dimensionally stable partial exoskeleton. The leg parts can move e.g. on the lower side in a longitudinal direction or even be dismantled separately e.g. by means of a hinge that can be opened. In fact, the leg parts should be dimensionally stable in the closed/“worn” state—when connected to a seat system—and respond to mechanical loads as a dimensionally stable whole. Accordingly, the connections of multi-part leg parts should be substantially rigid or only have very limited flexibility. When not connected to the seat system, the rigid or flexibly very limited connections of the multi-part leg parts can, to improve wear comfort, e.g. during walking, putting on or taking off, be loosened or even opened.

In a further aspect, the invention relates to a vehicle seat device for mounting a seated person with left and right leg parts according to the invention.

In a preferred embodiment, the leg parts of the vehicle seat device are allocated such that the upper leg of the seated person has an angle relative to the horizontal of at least 10 to 60, preferably 20 to 40, more preferably from 25 to 35, most preferably approximately 30 degrees. This angle is understood to mean the angle between the femur and the horizontal. Preferably, the angle is adjustable.

Vehicle seats having leg parts of this type angled to the horizontal retain the hips and the body of the seated person during a strong braking effect or a frontal impact, and thus prevent or attenuate a submersion “submarining”. The body can indeed slide forward a little within the tolerance of e.g. a safety belt, said body is then, however, decelerated against the force direction due to the inclined position of the leg parts. Advantageously, the leg parts, therefore, completely surround the knee e.g. by the shape contouring or by additional restraint systems such as belts and snap closures.

The seat device comprises preferably and substantially the leg parts and the connection, e.g. locking mechanism in the vehicle compartment or to other components of the vehicle seat, which connection guarantees a preferably angled leg position of the seated person. In the simplest embodiment, the seat device comprises the two separate dimensionally stable leg parts and a locking mechanism in the passenger compartment. The person can sit on the compartment floor, on a seat, or on the leg parts themselves (with a seat). Preferably, however, the seat device also comprises a backrest and/or a headrest. The backrest is preferably configured such that said backrest provides strong lateral support at the waist and/or at the chest. More particularly preferably, the backrest, apart from at the back, solely contacts the chest laterally below the shoulder joints. Most preferably, the backrest exclusively contacts at the back and sides beneath the shoulder joints in the thoracic region, i.e. said backrest is not under the chest.

In a preferred embodiment, the leg parts are lockably accommodated on the outer side and proximally to a vehicle cabin and/or a seat section of the vehicle seat. In addition, the seating device preferably comprises at least a seat, a backrest, a hip support and/or a headrest.

Preferably, the leg parts of the vehicle seat device and/or a vehicle cabin are movably allocated such that preferably at least a limited lateral deflection of the knee is possible. This contributes to the comfort, but not to the optimal vehicle sensory perception by the seated person.

It is also preferred that the leg parts are allocated at least partially elastically damping with respect to the vehicle seat and/or the vehicle cabin.

In further embodiments of the seat device, it is provided that the leg parts be simple and fast to release preferably by means of an emergency release device. Thus, the vehicle occupant, e.g. a racing car driver or a fighter pilot, can exit the vehicle “wearing” the leg parts. This can be take place on foot, with the help of third parties, or via an ejection seat. In many accidents involving “extreme vehicles”, the occupants are more or less seriously injured and may only be removed very carefully to avoid severe pain or consequent injuries (neck and spinal injuries).

Therefore, in a preferred embodiment of the seat device according to the invention, the leg parts are allocated or can be allocated to one or more other parts of the seat device, preferably to a seat part and/or a back part, such that that said parts support the body of the seated person even after removal from the vehicle. In other words, the seat components can be used as support components even after removal from the passenger compartment. In this context, it is advantageous if restraint systems such as safety belts remain on the seat device after removal from the passenger compartment in order to fix the injured person thereon. The seat device according to the invention can thus considerably facilitate and make safer the rescue of passengers.

In a further embodiment, therefore, the invention is directed to a vehicle extraction system comprising a seat device according to the invention and an extraction device, wherein the vehicle seat device has mounting points for the extraction device, by means of which mounting points at least parts of the seat device can be jointly recovered from the vehicle cabin, preferably in a spatially fixed relationship to one another.

As the shoulder is free, i.e. not connected to the thorax via a fixing hinge, it is not necessary to support the shoulder laterally to counter centrifugal forces in “extreme vehicles”. Conventional vehicle seats usually restrict the freedom of movement of the shoulder and of the arms.

In a further and also independent aspect of the leg parts according to the invention, said invention relates to a seat device, preferably a vehicle seat device or a vehicle seat extraction system having a preferably U-shaped support device for the back underneath the shoulders having lateral support for the chest, which solely surrounds the adjacent back and chest.

Preferably, but not necessarily, this seat device having the U-shaped support device to support for the back underneath the shoulders having lateral support for the chest, has leg parts according to the invention and also includes, in preferred embodiments, the variations in features described above for seat devices with leg parts according to the invention.

Due to the shape solely surrounding the back and the sides of the thorax, the back part is especially suited to supporting the upper body against lateral forces, as the surface adjacent to the thorax is significantly larger than in conventional seats. A further advantage is that this design, in contrast to conventional seats, does not support the soft tissues, but instead directly supports the skeleton. As the back part contacts the thorax, it is optimal for equipping with sensors, e.g. to measure heart activity. In addition, the shoulders and hips are free to move and are air cooled.

Further advantages, features and characteristics of the invention result from the following description of the drawings, in which individual embodiments are described in detail by way of example. Described and/or illustrated features, alone or in any reasonable combination, form the subject matter of the invention, if necessary independently of the claims, and can in particular also form additionally the subject matter of one or more separate invention(s). Identical, similar, and/or functionally identical parts are shown with the same reference number.

In the Figures:

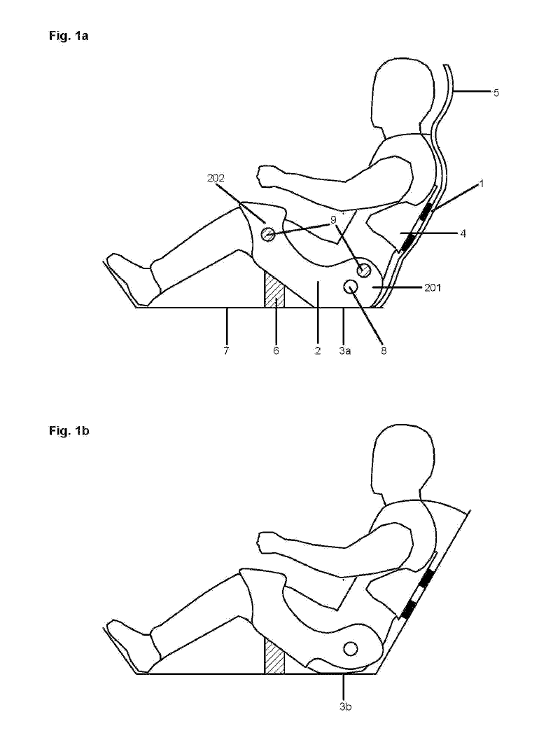

FIG. 1a shows a side view of a seat device according to the invention with leg part, seat, backrest, and headrest;

FIG. 1b shows a side view of a seat device according to the invention as in FIG. 1a with a cut-out at the buttocks and a backrest;

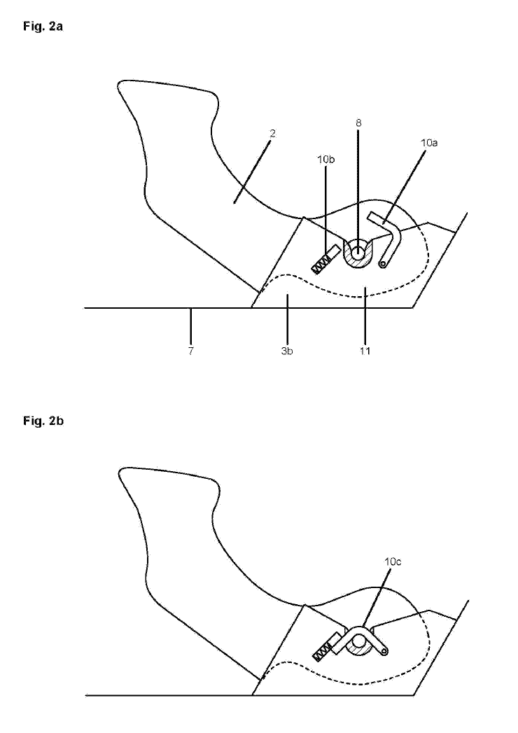

FIG. 2a shows a side view of a leg part according to the invention with a cut-out at the buttocks placed in a lateral accommodation with open locking lever and safety catch;

FIG. 2b shows a side view of the leg part according to the invention from FIG. 2a with closed locking lever;

FIG. 3a shows a three dimensional front view of a leg part according to the invention with a cut-out at the buttocks, cut-out at the knee, and padding on both sides at the knee and below and behind the hollow of the knee;

FIG. 3b shows a three dimensional front view of a leg part according to the invention as in FIG. 3a but with an integrated seat, wherein the seat and the surface contacting the lower upper leg preferably form a small angle with one another, preferably from 140 to 170, more preferably from 160 to 170 degrees;

FIG. 3c shows a three dimensional front view of a leg part according to the invention as in FIG. 3b, however without padding inside but with distal and proximal shock-absorbing elements on the outside;

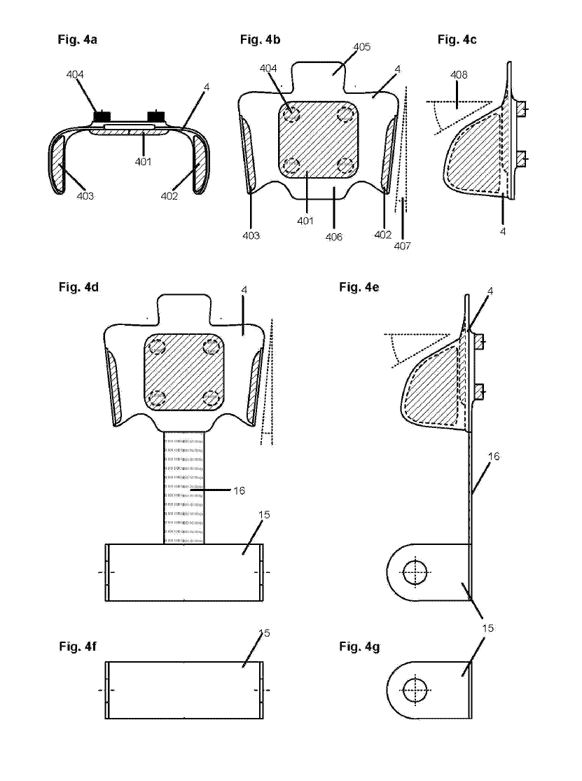

FIG. 4a shows a view from the top of a backrest according to the invention with rear surface, left and right support surfaces as well as rear (401), left (402) and right (403) padding as well as connecting elements to the vehicle;

FIG. 4b shows a front view of a backrest according to the invention with rear surface, left and right support surfaces as well as rear, left and right padding, as well as an upper and lower extension as well as a trapezoid-shaped waist;

FIG. 4c shows a side view of a backrest according to the invention with an angled lateral surface;

FIG. 4d shows a front view of a backrest according to the invention with connecting elements to the two leg parts;

FIG. 4e shows a side view of a backrest according to the invention from FIG. 4d;

FIG. 4f shows a front view of a connecting element for the two leg parts;

FIG. 4g shows a side view of a connecting element for the two leg parts;

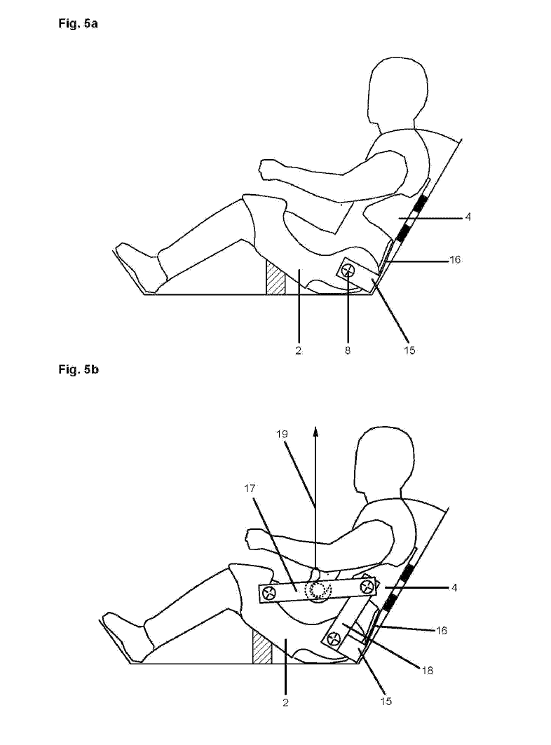

FIGS. 5a/b show two side views of vehicle seat extraction system according to the invention;

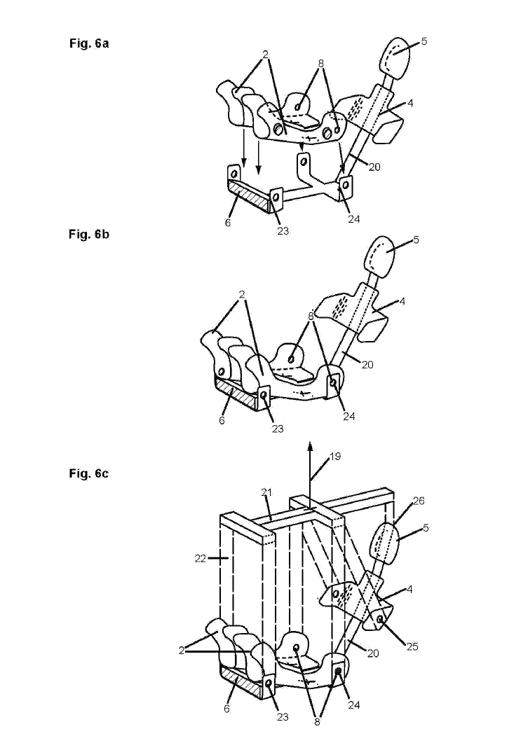

FIGS. 6a/b/c show three 3-D views of a vehicle seat extraction systems according to the invention without (6a/b) and with an extraction frame (6c).

In an exemplary seat device according to the invention, FIG. 1a shows a seat device (1) having leg part (2), seat (3a), backrest (4), and headrest (5), wherein the leg part (2) is proximally (201) connected (at the hips) to the floor of the passenger compartment (7) and is provided distally (202) with a vibration-damping elastic support (6). The seat is provided with a proximal seat locking (8) at the cabin floor (7) and two lateral proximal and distal shock-absorbing elements (9), which lessen a side impact. The leg parts (2) can in preferred embodiments of the invention freely rest on the elastic supports (6) or be allocated thereto by a rigid or elastic connection. Preferably, the connection is elastic and allows a rotation/turning around the longitudinal axis of the leg. However, should the leg parts be allocated with respect to the seat or the passenger compartment as a whole such that a lateral movement of the leg parts (2) (sideways deflection during cornering/banking) is restricted, or even excluded, such that the driver has not need for compensation movements to counter lateral forces and, instead, can concentrate fully on his steering.

In FIG. 1b, which is largely identical to FIG. 1a, a preferred seat device (1) is shown with a leg part (2) with a cut-out for the buttocks (3b) and a backrest (4). The cut-out facilitates walking with the leg parts, enables an extremely flat sitting in the vehicle cabin and reduces weight.

As shown in FIG. 2a, a leg part (2) according to the invention with a cut-out for the buttocks (3b) can be used in a lateral mounting (8) in the vehicle cabin with open locking lever (10a) and safety catch (10b) and, by closing the locking lever (10c) (see FIG. 2b) and advancing the safety catch, be securely fixed and limited to upwards and downwards movement.

Of the three embodiments in FIGS. 3a to 3c, FIG. 3a shows a leg part (2) according to the invention with a cut-out for the buttocks (3b), a cut-out at the hollow of the knee (13) and padding on both sides of the knee (12) and beneath and behind the hollow of the knee (14). FIG. 3b shows a largely similar leg part (2) as that shown in FIG. 3a but with a seat (3a); the leg part (2) of FIG. 3c is identical to the leg part (2) of FIG. 3b except for the lack of padding and the provision on the outside of distal and proximal shock- absorbing elements (9).

FIG. 4a shows a backrest (4) according to the invention with a rear surface, left and right support surfaces as well as rear (401), left (402) and right (403) padding and connecting elements to the vehicle (404). The embodiment of FIG. 4b shows the front view of a backrest (4) according to the invention with a rear surface, left and right support surfaces as well as rear (401), left (402) and right (403) padding, as well as an upper (405) and lower extension (406) and a trapezoid-shaped waist (407).

As shown in FIG. 4c, the backrest (4) according to the invention has a downward sloping lateral surface. FIG. 4d shows a backrest (4) according to the invention from the front with a connecting element (15), which allocates the two leg parts to the backrest (4) via the connecting element (16).

FIG. 4e shows the backrest (4) with the connecting elements (16) and (15) from the side; FIGS. 4f and 4g, respectively show a front and side view of a connecting element (15) for the two leg parts.

In FIG. 5a, in the context of a seat device according to the invention, a connection element (15) is shown for the fixing of the two leg parts (2) to the mounting point (8) of the leg parts and the connecting element (16) for connecting the leg parts (2) to the backrest (4).

FIG. 5b shows the seat device of FIG. 5a as a component of a vehicle seat extraction system with the extraction device (19) comprising fixed part elements (18) which connect the lateral surfaces of the backrest (4) with the proximal region of the leg parts (2), and the connecting element (17) which connects the lateral surfaces of the backrest (4) with the distal part of the leg parts (2) and spatially fixes this arrangement and thus allows the recovery of the person in a fixed position.

FIG. 6a shows a 3-D view of a preferred extraction frame (20) with headrest (5), a backrest (4), a damping support element (6) and mountings (23) and (24) for the leg parts (2) with mounting (8).

FIG. 6b shows the extraction frame (20) of FIG. 6a with inserted and fixed leg parts (2) which are connected to the frame via the mountings (23) and (24) of the extraction frame (20), said leg parts at the distal end thereof rest on the damping support element (6).

FIG. 6c shows a vehicle seat extraction system with vehicle seat and extraction device (19) with extraction frame (20), wherein the cross and carrying strut (21) of the extraction device (19) is connected via a plurality of connecting elements (22) to the mountings (23, 24) on the seat frame (20) as well as the mounting (25) on the backrest (4) and the mounting (26) on the headrest (5).

All previously described features of the leg parts, seat devices, vehicle seat extraction systems, as well as backrests can if necessary be combined with further partial aspects of the invention with respect to FIGS. 1-6. Furthermore, all partial aspects can represent independent inventions.

### REFERENCE NUMBERS

1 Seat device
2 Leg part
3a Seat
3b Cut-out for buttocks
4 Backrest
401 Padding/information part rear side
402 Padding/information part left side
403 Padding/information part right side
404 Connection part to the vehicle
405 Upper spine extension
406 Lower spine extension
407 Waist angle backrest
408 Angle for cut-out for elbow room
5 Headrest
201 Proximal leg part (hip)
202 Distal leg part (knee)
6 Elastic support
7 Floor of the passenger compartment
8 Lateral mounting
8a Shock-absorbing element in mounting
9 Shock-absorbing elements
10a Locking lever open
10b Safety catch
10c Locking lever
11 Floor group
12 Knee padding
13 Knee cut-out
14 Distal padding
15 Leg parts connecting element
16 Connecting element backrest-connecting element (15)
17 Connecting element of the lateral surfaces of the backrest (4) to the distal leg parts (2)
18 Connecting element of the lateral surfaces of the backrest (3) to the proximal leg parts
19 Extraction device
20 Seat frame
21 Cross and carrying strut of the extraction device (19)
22 Connecting element of the strut (21) to the seat frame (20)
23 Distal mounting for the extraction device
24 Mounting for the extraction device at the lateral surfaces of the backrest
25 Mounting for extraction device at the headrest

1. A dimensionally stable leg part (2) that can be allocated to a seat device (1), which is respectively allocated to a left or right upper leg (3) of a person from the knee to the hip and is in close contact to the upper leg, characterized in that the leg part (2a, 2b) contacts flat to the outside of the hip, on the underside of the upper leg at least on the distal end, and at least inside and outside on the knee.

2. The leg part according to claim 1, characterized in that it has at least one locking device on the side and/or underneath at the proximal end (hip) as well as optionally on the side and/or underneath along the upper leg up to the knee for the fixable and detachable connection to a vehicle seat device and/or passenger compartment.

3. The leg part according to claim 1, characterized in that it is connected to the person in such a way that said leg part can be worn as an article of clothing by the person in the unfastened state from the vehicle seat.

4. The leg part according to claim 1, characterized in that the inside thereof is not padded at all, or is only slightly padded, and is preferably smooth.

5. The leg part according to claim 1, characterized in that it at least partially or completely contacts the upper side of the knee.

6. The leg part according to claim 1, characterized in that it is at least partially permeable to air, preferably perforated.

7. The leg part according to claim 1, characterized in that it is provided with shock-absorbing elements on the outside, preferably at least at the proximal and distal ends.

8. The leg part according to claim 1, characterized in that there is a cut-out for the buttocks of the wearer.

9. The leg part according to claim 1, characterized in that the distal end thereof is equipped with sensors, preferably at the knee, preferably on the inside, outside and/or underside of the knee.

10. The left and right leg parts according to claim 1, articulated to each other at the proximal end (hips), preferably flexibly connected to each another.

11. A vehicle seat device (1) for supporting a seated person (2) with left and right leg parts (2a, 2b) according to claim 1.

12. The vehicle seat device (1) according to claim 11, characterized in that the leg parts (2a, 2b) of the vehicle seat device (1) are allocated such that the upper leg (3) of the seated person has an angle relative to the horizontal (4) of at least 10 to 60, preferably 20 to 40, more preferably 25 to 35, most preferably approximately 30 degrees.

13. The vehicle seat device according to claim 1, characterized in that the leg parts can be lockably allocated on the outer side and proximal to a vehicle cabin and/or a seat of the vehicle seat.

14. The vehicle seat device according to claim 1, characterized in that the angle of the leg parts is adjustable relative to the horizontal.

15. The vehicle seat device according to one of claim 1, characterized in that the seat device additionally comprises at least a seat, a backrest, a hip support and/or a headrest.

16. The vehicle seat device according to one of claim 1, characterized in that the backrest except at the back solely contacts the chest laterally below the shoulder joint.

17. The vehicle seat device according to claim 1, characterized in that the leg parts of the seat device and/or a vehicle cabin movably allocated such that preferably at least a limited sideways deflection of the knee is possible.

18. The vehicle seat device according to claim 1, characterized in that the leg parts are allocated at least partially elastically damping with respect to the vehicle seat and/or the vehicle cabin.

19. The vehicle seat device according to claim 1, characterized in that the leg parts are or can be allocated to one or more other parts of the seat device, preferably a seat and/or a backrest such that said parts support the body of the seated person even after removal from the vehicle.

20. A vehicle seat extraction system comprising a vehicle seat device according to claim 1, and an extraction device, characterized in that the vehicle seat device has mounting points for the extraction device, by which means at least parts of the seat device can be jointly recovered from the vehicle cabin, preferably in a spatially fixed relationship to one another.

21. A seat device, preferably a vehicle seat device or vehicle extraction system, having preferably a U-shaped support device for the back underneath the shoulders having lateral support for the chest that solely surrounds the adjacent back and chest.
